(19) United States
(12) Patent Application Publication
(10) Pub. No.: US 2006/0046022 A1
(43) Pub. Date: Mar. 2, 2006

(54) Thermally-resistant composite fabric sheet

(76) Inventors: Yves Bader, Thoiry (FR); Genevieve M. Laverty, Troinex (CH)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/929,131

(22) Filed: Aug. 27, 2004

(51) Int. Cl. B32B 3/06; G11B 5/64; B32B 1/00; D04H 13/00

(52) U.S. Cl. 428/102; 442/327; 428/141; 428/174

(57) ABSTRACT

A thermally-resistant composite fabric sheet for use as single or outer layer of protective garments, comprises inside and outside fabric layers (B,A) joined together by an array of connection lines (12,22,32) arranged so that the inside layer forms bubble-like pockets (16) when the outside layer (A) is caused to shrink by the external application of intense heat. The array of connection lines (12,22,32) is constituted by a plurality of isolated single connection lines (22) and/or by a plurality of isolated groups of connection lines (12,32), for example forming a series of Y or V shapes. The connection lines are arranged at different angles and are spaced apart from one another to leave gaps (42) where the two layers (A,B) are not connected to one another. These gaps (42) unite a continuous expanse (40) of the two unconnected layers that surrounds each isolated connection line (22) or group of connection lines (12,32). This continuous expanse (40) has a labyrinth-like structure delimited by the connection lines (12,22,32) at different angles, such that when a given area of the outside layer (A) is subjected to intense heat resulting in thermal shrinkage the inside layer (B) forms under the given area a series of self-closing bubble-like pockets (16) that form individually in discrete areas of the continuous expanse (40) between the connecting lines (12,22,32) and that are inhibited by the labyrinth-like structure from propagating along or across the sheet.

### FIELD OF THE INVENTION

This invention relates to a thermally-resistant composite fabric sheet for use as single or outer layer of protective garments, of the type comprising an inside fabric layer and an outside fabric layer joined together by an array of connection lines arranged so that the inside layer forms bubble-like pockets when the outside layer is caused to shrink by the external application of intense heat.

### BACKGROUND OF INVENTION

Thermally resistant fabric sheets for use as single or outer layer of protective garments are known in the art.

WO 00/66823 discloses a fire resistant material made of woven meta-aramid and polyamideimide fibers strengthened by an interwoven mesh of para-aramid fibers or polyparaphenylene terephthalamide, and fire resistant clothing made of this material.

WO 021079555 discloses a reinforced fabric especially for thermal protection clothing, the fabric being reinforced by interlaced warp yarn weaves and weft yarn weaves of high-strength materials.

WO 02/20887 discloses a fire resistant material comprising a woven faced fabric composed of meta-aramid fibers, polyamideimide fibers and mixtures thereof, and a woven back fabric of low shrinkage fibers selected from para-aramid, polyparaphenylene terephthalamide copolymer and their mixtures. The two layers could be interwoven together at points forming a sort of grid.

WO 03/039280 describes a sheet of complex or multilayer structure especially intended for a thermal barrier in protective clothing for fire fighters, where the layers of material are interwoven to form pockets. The outer layer shrinks under the effect of heat to form pockets underneath, the pockets forming tubes along the inside face. FIGS. 5 and 7 of this prior art document illustrate the pockets and the interweaving pattern, respectively.

WO 03/039281 describes a sheet of complex or multilayer structure for thermal barriers in fire fighters' protective clothing, where the layers of material are interwoven such that when the outer layer shrinks under the effect of heat the connecting fibers straighten to increase the space between the layers.

WO 2004/023909 discloses a heat, flame and electric arc resistant fabric for use as a single or outer layer of protective garments. It comprises an inside fabric layer and an outside fabric layer joined together by an array of connection lines arranged so that the inside layer forms bubble-like pockets when the outside layer is caused to shrink by the external application of intense heat. The described embodiments provide for a chequer pattern of closed pockets so that heat-conducting tubes are not formed when the outside fabric layer is caused to shrink.

Despite these proposals, there remains a need for thermally-resistant fabrics that combine wearer comfort, high thermal performance and improved physical characteristics after the fabrics have been exposed to intense heat.

### SUMMARY OF THE INVENTION

The invention provides a thermally-resistant composite fabric sheet of the above-mentioned type wherein the array of connection lines is constituted by a plurality of isolated single connection lines and/or by a plurality of isolated groups of connection lines. The connection lines are arranged at different angles and are spaced apart from one another to leave, between the isolated single connection lines and/or between the isolated groups of connection lines, gaps where the two layers are not connected to one another. These gaps unite a continuous expanse of the two unconnected layers that surrounds each isolated connection line and/or each isolated group of connection lines. This continuous expanse of the unconnected fabric layers has a labyrinth-like structure delimited by the connection lines at different angles such that, when a given area of the outside layer is subjected to intense heat resulting in thermal shrinkage, the inside layer forms under the given area a series of self-closing bubble-like pockets that form individually in discrete areas of the continuous expanse between the connecting lines and that are inhibited by the labyrinth-like structure from propagating along or across the sheet outside said given area.

The connecting lines or groups of connecting lines are isolated and surrounded like islands in the expanses of unconnected fabric layers, with the connecting lines at angles forming a sort of labyrinth that prevents the bubbles from forming tubes.

The connection lines are conveniently arranged in a geometrically repeating pattern with the continuous expanse forming wavy paths that meander around the pattern of lines. The connecting lines can for example be arranged in a plurality of groups each composed of a plurality of connecting lines arranged for instance in a generally Y, V, L, T, H, X or Z configuration with the lines extending from at least one convergence point, the lines being connected together at, or being spaced apart from, their convergence point(s).

The special structure of the thermally-resistant composite fabric sheet according to the invention provides a combination of properties unattainable with prior art structures, in particular a combination of high thermal performance with improved physical characteristics after the fabrics have been exposed to heat, which leads to enhanced wearer comfort due to the fact that these performances can be achieved with fabrics of lower weight. Therefore, garments of the same thermal performance can be made with lighter fabrics, making the garments more comfortable to wear.

When the outer face of the fabric according to the invention is, for example, exposed to a flame or another intense source of heat, the outside fabric layer is caused to shrink. The inside layer is shielded from the heat source and does not shrink, or shrinks much less. Shrinkage of the outside fabric layer is constrained by the connection lines that are isolated in a pattern, surrounded by the unconnected layers. The bubble-like pockets that form are localized under the heated area; the limited propagation of these self-closing pockets means that the thus-formed insulating space is effective to protect the underlying area. Thus, heat is not unwantedly transmitted to adjacent areas by the formation of tubes. This formation of bubble-like air spaces under the area that is exposed to intense heat provides the high thermal performance of the fabric.

After exposure to intense heat, the fabric also has improved physical characteristics, namely a good tear resistance and tensile strength. When the heated outside layer shrinks, it acts as a heat absorber, sacrificing some of its physical strength, while the inside layer remains intact. Furthermore, the connecting lines uniting the two fabric layers also sacrifice some physical strength leading to a weakness of the fabric along such lines where the fabric can tear. However, due to the peculiar discontinuity in the connecting lines and the resulting unconnected expanses of the fabric according to the present invention, such tears cannot propagate to other zones which have not been exposed to heat and which are therefore undamaged. As a result, the outer layer of the fabric sheet demonstrates improved tear resistance and outstanding tensile strength after exposure to intense heat, the inside layer remaining protected and the intact unconnected expanse of the inside layer retaining its strength. This could be extremely important for firemen's clothing where, for example, a fireman in a burning structure has to be pulled by his clothing to remove him from a critical situation.

As mentioned, the new fabric combination of high thermal performance and improved physical characteristics after exposure to heat contributes to the wearer comfort of heat-resistant garments based on this fabric. The garments made with the fabric according to the present invention are lighter and more flexible, thus more comfortable to wear, by maintaining the same thermal performance of the garments known in the art. In applications where even higher thermal performance and strength after exposure to heat are required, this can be achieved using the fabric of the invention of the same, or even lighter weight as the conventional fabrics, the final garment fulfilling the required higher thermal performance by maintaining lightness and flexibility.

In addition to good physical properties like tensile strength and tear strength, the composite fabric sheet according to the invention displays excellent abrasion resistance that is appreciated particularly for outershell fabrics.

Further features of the invention are set out in the claims and in the following detailed description and examples.

### BRIEF DESCRIPTION OF DRAWINGS

In the accompanying schematic drawings given by way of example:

FIG. 1 is a diagrammatic view of one embodiment of a thermally-resistant composite fabric sheet according to the invention, with an array of Y-shaped connection lines;

FIG. 2 schematically illustrates the formation of bubble-like pockets on the inside layer of the thermally-resistant composite fabric sheet of FIG. 1 after exposure of the outside layer to heat;

FIGS. 2A and 2B are diagrammatic cross-sections along lines 2A and 2B of FIG. 2, and FIG. 2C is a diagrammatic elevational view showing how bubble-like pockets formed in the array of Y-shaped connection lines are offset from one another;

FIG. 3 schematically illustrates the fabric continuity in the unconnected parts of the thermally-resistant composite fabric sheet of FIG. 1;

FIG. 4 is a diagram of another embodiment of a thermally-resistant composite fabric sheet according to the invention with an array of isolated individual connection lines; and

FIG. 5 is a diagram of a further embodiment of a thermally-resistant composite fabric sheet according to the invention with an array of discrete connection lines in the shape of flattened Vs.

### DETAILED DESCRIPTION

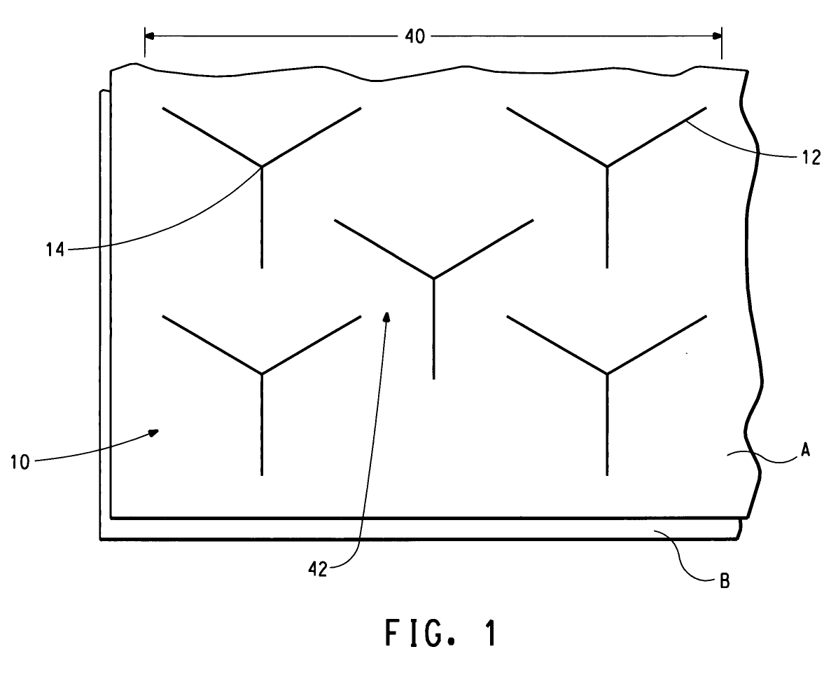

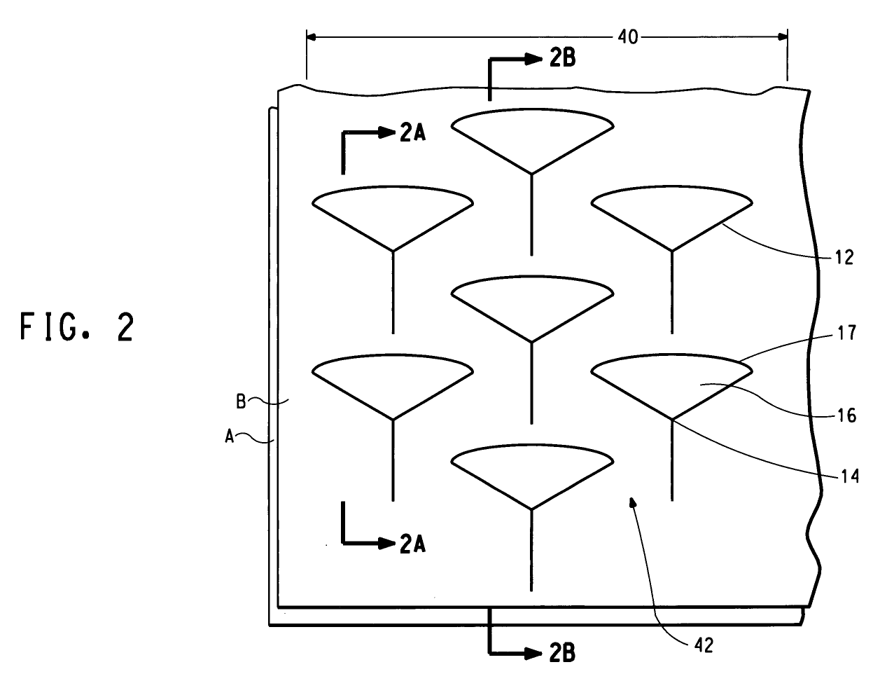

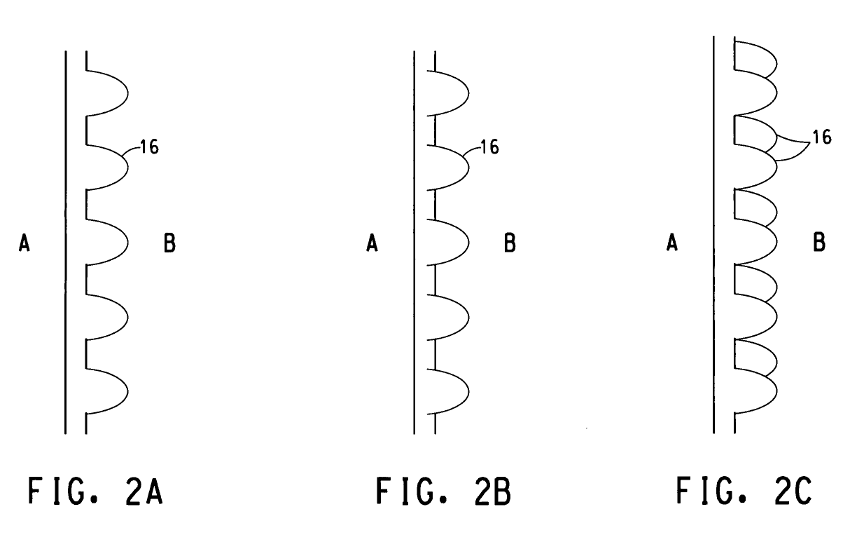

FIGS. 1 to 3 schematically illustrate a first embodiment of a thermally-resistant composite fabric sheet according to the invention for use as single or outer layer of a protective garment. This fabric sheet comprises an outside fabric layer A and an inside fabric layer B joined together by an array 10 of connection lines 12 arranged so that the inside layer B forms bubble-like pockets 16 (FIG. 2) when the outside layer A is caused to shrink by the external application of intense heat.

As shown in FIG. 1, the array 10 is made up of a plurality of groups of connecting lines, each group being composed of three connecting lines 12 arranged in a Y shape. In this example the three lines 12 of each Y are of substantially equal length and extend at substantially equal angles (of 120°) from a convergence point 14 where the lines 12 are connected together.

In alternative embodiments which also have Y-shaped connecting lines, only two of the three lines 12 making up each Y are of substantially equal length and are arranged symmetrically and at equal oblique angles to the third line.

As shown in FIG. 1 the array 10 of Y-shaped connecting lines 12 is composed of vertical rows of Ys with adjacent lines of groups offset to one another (only one of the Y-shaped connecting lines 12 of the middle row is shown).

In the example of FIG. 1, the three lines 12 of each Y are all parallel to corresponding lines 12 of the other Y-shaped groups. Moreover the parallel lines 12 of different groups are all exactly or approximately aligned with and parallel to lines 12 of the other groups. So, the vertical stems of the Ys are aligned in vertical rows, and the inclined arms of the Ys are also aligned along rows at 120° to the vertical.

In the example of FIG. 1, the parallel lines 12 of adjacent vertical rows of Y-shaped groups are offset or staggered vertically, as can be seen for the illustrated Y-shaped group of the middle row in FIG. 1. The Y-shapes of every alternate vertical row of the Y shapes are aligned both vertically and horizontally, as can be seen for the left and right vertical rows in FIG. 1. The Y shapes are also aligned at 120° angles.

In general, pluralities of groups of connecting lines 12 like the illustrated Y shapes can be aligned in rows in at least two different directions across the fabric sheet. For instance, the illustrated Y-shaped group forming the middle row of vertically-offset Y shapes can be omitted, leaving all the Y-shapes aligned vertically and horizontally in rows.

Each Y-shaped group of connecting lines 12 is isolated from the other groups. The connection lines 12 are arranged at different angles and are spaced apart from one another to leave, between the isolated Y-shaped groups of connection lines 12, gaps 42 where the two layers A,B are not connected to one another. These gaps 42 unite a continuous expanse 40 of the two unconnected layers A,B that surrounds each isolated Y-shaped group of connection lines 12. This continuous unconnected expanse 40 of the fabric layers has a labyrinth-like structure delimited by the connection lines 12 that are at different angles.

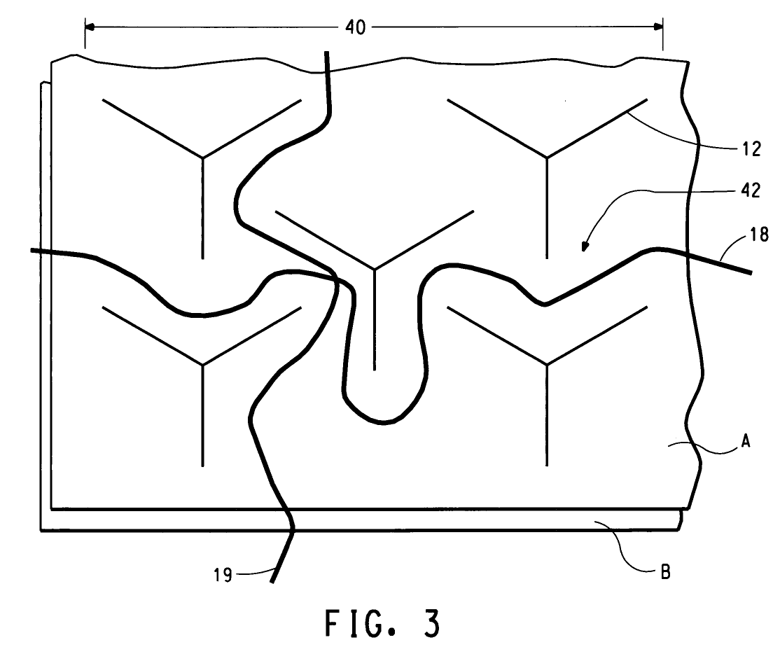

This labyrinth-like structure is schematically represented in FIG. 3 by a notional generally horizontal path represented by the wavy line 18 and by a notional generally vertical path represented by the wavy line 19. It can be seen that these wavy lines 18, 19 meander through the gaps 42 between the different connection lines 12, these gaps 42 forming part of the continuous expanse 40 that surrounds the isolated Y-shaped connection lines 12.

When the outside layer A shrinks as a result of the application of intense heat, the inside layer B forms, underneath the heated area, a series of bubble-like pockets 16 that form individually in discrete areas of the continuous expanse 40 between the connecting lines 12. The pockets 16 are very schematically shown in FIG. 2 and in FIGS. 2A, 2B and 2C with much exaggerated dimensions. Each pocket 16 is delimited by a curved boundary 17. The two sheets A,B are unconnected at this boundary 17 which forms as a result of the forces acting, this closing up at the boundary corresponding to the self-closing effect of the bubble-like pockets 16. Of course, the boundary 17 is not geometrically defined and in fact the bubbles can have different shapes delimited generally by the connection lines 12. These pockets 16 are inhibited by the labyrinth-like structure formed by lines 12 from propagating along or across the sheet. This means that the pockets 16 will form locally with a greatly reduced tendency to form tubes along or across the sheet, compared to some prior art structures. Some small bubble propagation is nevertheless possible within the heated area, in particular with the formation of C or S shaped bubbles. In this way, the structure confines the insulating bubble formation essentially to the area under the heated zone (where insulation is needed), and avoids propagation of tubes outside the heated zone that would unwantedly distribute heat.

As illustrated in FIG. 2c, the bubble-like pockets 16 formed in alternate rows of the Y-shaped connecting lines 12 will be correspondingly staggered. The shape of the bubble-like pockets 16 and their distribution over the heated area will of course depend on the configuration of the array of connecting lines 12.

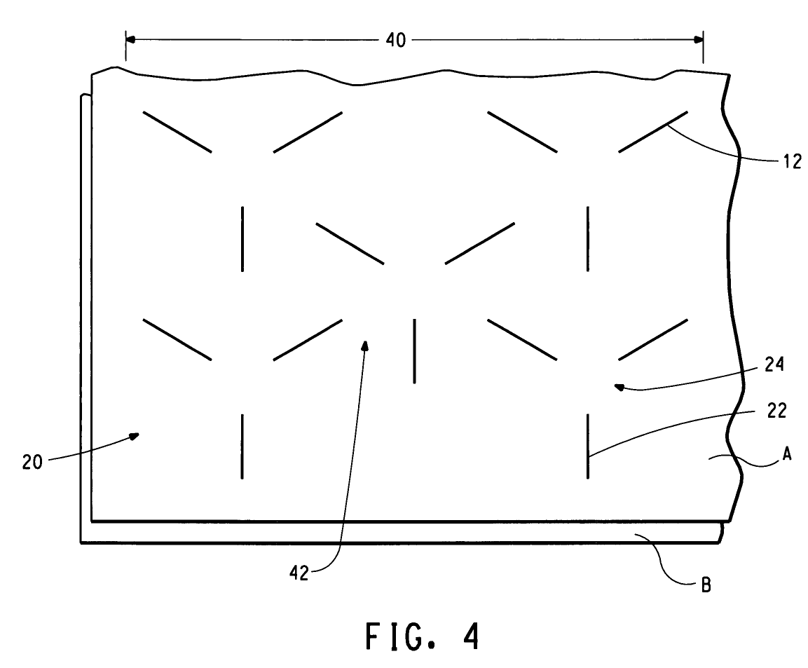

FIG. 4 shows another embodiment of the thermally-resistant composite fabric sheet made of an outside fabric layer A and an inside fabric layer B. In this variation an array 20 of isolated connecting lines 22 are arranged grouped like Ys as in FIG. 1, but the three lines 22 making up each Y-shape are all spaced apart from a point of convergence 24. This point of convergence 24 leaves an area of the layers A,B that merges with the gaps 42 and forms part of the continuous expanse 40. With this design, bubble-like pockets will form in the inside fabric layer B in the same way as for the embodiment of FIG. 1, and the bubbles will remain localized under the heated area because the connecting lines 22 at different angles inhibit the bubbles from propagating into tubes. In this embodiment, the continuous expanse 40 extends around the individual isolated connecting lines 22 which will also lead to improved tensile strength and tear strength.

In this variation, the connecting lines 22 consist of lines at 120°, broken in their middle by gaps 24. In this case, the shape of the bubble-like pockets would be different but as in the previous closed Y-configuration the bubbles will close along the gaps between the lines avoiding heat propagation like in tubes. Also, the extra gaps 24 between the connecting lines 22 will contribute to good tensile and tear strength.

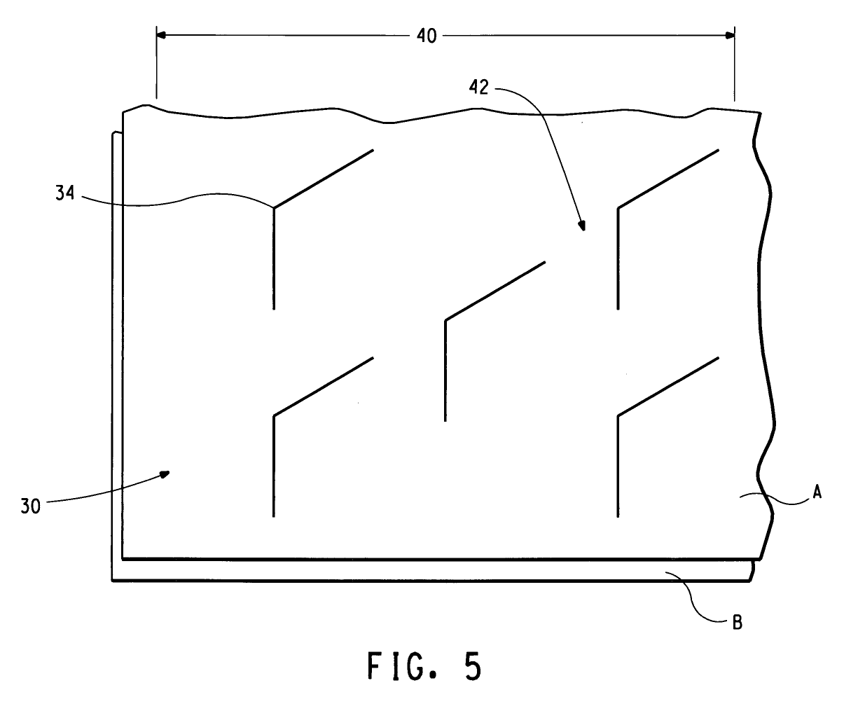

FIG. 5 shows a further embodiment of the thermally-resistant composite fabric sheet made of an outside fabric layer A and an inside fabric layer B. In this variation there is an array 30 of pairs of connecting lines 32 connected together in a generally V-shape. As illustrated, the two lines of V-shape are connected at an angle of about 120°. This angle will normally be at least 60°, and usually at least 90° and preferably at least 120°. As illustrated these V-shapes can be aligned in rows with their sides all aligned with or parallel to the corresponding sides of the other V-shapes. Gaps 42 are left between the adjacent V-shapes, these gaps 42 merging with the continuous expanse 40. With this design, bubble-like pockets will form in the inside fabric layer B in a similar way to the embodiment of FIG. 1, and the bubbles will remain localized under the heated area because the connecting lines 32 at different angles inhibit the bubbles from propagating into tubes. In this embodiment, the continuous expanse 40 extends around the isolated V-shaped connecting lines 22 which will also lead to improved tear strength.

In a variation of FIG. 5, the lines 32 forming a V-shape could be spaced apart at their point of convergence.

Other shapes of individual and grouped connecting lines are possible, for example L-shapes, T-shapes, H-shapes, X-shapes, Z-shapes and so on (with or without gaps in the shapes), and it is also possible to include a plurality of curved connecting lines as individual lines in say C-shape or S-shape, or grouped lines where two straight lines are connected by a curved section for example to form a U-shape. Various shapes and patterns can also be composed from an array of individual isolated connection lines.

Preferably, the inside fabric layer B and outside fabric layer A are both woven fabrics and are joined together by an array of woven connection lines formed by interwoven threads making up the fabrics, using known techniques.

Advantageously, at least one of the inside and outside fabric layers B,A is made from a fiber blend comprising a first inherently flame resistant fiber of relatively low modulus, a second inherently flame resistant fiber of relatively high modulus, and sacrificial fibers having a lesser resistance to flames, for instance a fiber blend comprising from about 40 to 60 wt % meta-aramid fibers of relatively low modulus, about 20 to 40 wt % of para-aramid fibers of relatively low modulus, and about 10 to 30 wt % of pre-oxidised polyacrylonitrile as sacrificial fibers. However, many other fire-resistant fabrics can be used. Several examples are given below.

The invention also concerns garments, in particular garments for exposure to high temperature environments wherein the outside fabric layer A of the described fabric sheet is disposed on the outside of the garment. In some types of garment, this fabric sheet is unlined and the outside fabric layer A of the fabric sheet is oriented outwards.

Alternatively, the inside fabric layer B is lined with one or more further fabric layers in a multilayer structure. Such multilayer structure preferably comprises an internal layer, optionally an intermediate layer made of a breathing waterproof material, and an outer layer made of a sheet of the fabric according to the invention.

The internal layer, which faces the body of the wearer, can be an insulating lining made for example of a fabric of two, three or more plies. The purpose of such lining is to have an additional insulating layer further protecting the wearer from the heat.

The internal layer can be made of a woven, a knitted or a non-woven fabric. Preferably, the internal layer is made of a fabric comprising non-meltable fire resistant materials, such as a fleece or a woven fabric of meta-aramid.

The garment according to the present invention can be manufactured in any possible way. It can include an additional, most internal layer made, for example, of cotton or other materials. The most internal layer directly faces the wearer's skin or the wearer's underwear.

The garment according to the present invention can be of any kind including, but not limited to jackets, coats, trousers, gloves, overalls and wraps.

The invention will be further described in the following examples.

### EXAMPLE 1

A blend of fibers, commercially available from E.I. du Pont de Nemours and Company, Wilmington, Del., U.S.A., under the trade name Nomex® N307, having a cut length of 5 cm and consisting of:
93 wt % of pigmented poly-metaphenylene isophthalamide (meta-aramid), 1.4 dtex staple fibers;
5 wt % of poly-paraphenylene terephthalamide (para-aramid) fibers; and
2 wt % of carbon core polyamide sheath antistatic fibers was ring spun into one type of single staple yarns Y1 using conventional cotton staple processing equipment.

Yarn Y1 had a linear density of Nm 70/1 or 143 dtex and a twist of 920 Turns Per Meter (TPM) in the Z direction. Y1 was subsequently treated with steam to stabilize its tendency to wrinkle. Two Y1 yarns were then plied and twisted together. The resulting plied and twisted yarn (TY1) had a linear density of Nm 70/2 or 286 dtex and a twist of 650 TPM in the S direction. TY1 was used as warp and weft yarn.

TY1 yarns were woven into a two-plies weave fabric having an array of connection lines as described previously. The fabric was woven according to the construction depicted in FIG. 1. The arms of the Y-shaped connection lines 12 were approx. 10 mm long, and the gaps 42 measured approx. 5 mm. The weave fabric had 38 ends/cm (warp) (19 ends/cm for each ply), 36 weft/cm (weft) (18 ends/cm for each ply) and a specific weight of 219 g/m². The following physical tests were carried out on the thus-obtained fabric:
Determination of the breaking strength and elongation according to ISO 5081;
Determination of the tear resistance according to ISO 4674;
Determination of the dimensional change after washing and drying according to ISO 5077;
Combined radiant and convective heat testing according to the TPP method (NFPA 1971:2000, section 6-10, ISO 17492) as a single layer with a heat flux calibrated to 2.0 cal/cm²/s, the TPP rating being the energy (cal/cm²) measured to simulate a second-degree burn on the skin of an individual;
Determination of single layer fabric thickness according to DIN 53855 before and after 4 s heat exposure at the TPP test with a heat flux calibrated to 2.0 cal/cm²/s.

The fabric obtained under this Example 1 was tested both as single layer (“Fabric” in Table 1a) and as the outershell of a multilayer structure (“Garment” in Table 1a). This multilayer structure further comprised: (1) an intermediate layer of a PTFE membrane laminate on a non-woven fabric made of 85 wt % Nomex® and 15 wt % Kevlar® and having a specific weight of 135 g/m² (commercially available under the trade name GORE-TEX® Fireblocker N from W. L. Gore and Associates, Delaware, U.S.A.), and (2) an internal layer of a meta-aramid thermal barrier having a specific weight of 140 g/m² quilted on a 100 wt % Nomex® N 307 fabric having a specific weight of 110 g/m².

The fabric structure swelled while undergoing the combined radiant and convective heat testing, by the formation of bubble-like pockets 16 as previously described. The results of the tests are given in Table 1a.

TABLE 1a

| | Warp | Weft |
|---|---|---|
| Breaking strength (N) | 1200 | 1145 |
| Elongation (%) | 40.3 | 36.4 |
| Tear resistance (N) | 156.1 | 173.8 |
| Dimensional change | −1.5 | −2.0 |
| after washing (%) | | |

| | |
|---|---|
| Fabric Thickness | 0.8 |
| before heat exposure | |
| (mm) | |
| Fabric Thickness after | 2.4 |
| 4 s heat exposure (mm) | |
| Specific Weight | 219 |
| (Fabric) (g/m²) | |
| Specific Weight | 604 |
| (Garment) (g/m²) | |
| TPP (Fabric) | |
| Time to record pain (s) | 5.4 |
| Second degree burn (s) | 8.1 |
| TPP rating (cal/cm²) | 16.1 |
| Fabric Failure Factor | 7.4 |
| (10⁻² cal/g) | |
| TPP (Garment) | |
| Time to record pain (s) | 15.9 |
| Second degree burn (s) | 23.2 |
| TPP rating (cal/cm²) | 46.3 |
| Fabric Failure Factor | 7.7 |
| (10² cal/g) | |

Table 1a shows an excellent performance of the fabric, in particular with regard to the Fabric Failure Factor (FFF), which is defined as follows:
FFF=TPP (cal/cm²)/fabric specific weight (g/m²).

The fabric tested as single layer had an FFF value of 7.4×10² cal/g while a similar fabric of the same specific weight and the same materials, but woven according to a standard twill construction, had an FFF value of less than 6.6×10² cal/g. This value is considered by persons skilled in the art to be a technical barrier which conventional single layer fabrics available on the market and having similar weights and made of similar materials have never been able to attain and pass.

The fabric tested as the outershell of a multilayer structure had an FFF value of 7.7×10² cal/g, while comparable conventional multilayer structures have FFF values ranging between 5.2×10² and 6.7×10² cal/g.

These excellent results are explained by the swelling of the fabric upon heat exposure into the bubble-like pockets 16 that prevent heat convection.

Table 1a shows a high increase of thickness after 4 seconds equal to a factor of ×3. Table 1a also shows an excellent behavior in terms of tear strength after exposure to heat. The indicated tear resistance after exposure to heat is 2 to 3 times more than that of conventional fabrics of the same weight and composition.

The fabric was tested as single layer in accordance with the TATE (Tensile After Thermal Exposure) method. This method is based on the determination of breaking strength and elongation (Strip method) according to the standard ISO 5081 before and after TPP exposures of 2 s and 4 s with a heat flux calibrated to 2.0 cal/cm²/sec. The test conditions were:

| | |
|---|---|
| Testing machine: | constant rate of traverse (CRT) with a load cell |
| | of 2000 N |
| Gauge length: | 200 ± 1 mm |
| Sample width: | 50 ± 0.5 mm |
| Speed of traverse: | 100 mm/min. |

The results are summarized in Table 1b.

TABLE 1b

| | | 0 s | 2 s | 4 s |
|---|---|---|---|---|
| Breaking strength | N | 1200 | 650 | 315 |
| Elongation at break | % | 40.3 | 15.7 | 8.5 |

Prior art fabric according to WO 2004/023909-A2, with the same composition but continuous and connected lines would show a weight normalized breaking strength value after 2 s of 1.50 N.g⁻¹cm² (that is the breaking strength value divided by the fabric specific weight, the breaking strength value being measured according to the TATE method), while the fabric of this example has a value of 2.97 N.g⁻¹cm². This clearly shows that the integrity of the fabric is maintained due to its construction with unconnected zones. The fabric is therefore eminently suitable for single layer protective garments in industrial applications where there is a risk of heat and flame exposure.

### EXAMPLE 2

Two-ply weave fabrics having an array of Y-shaped connection lines as shown in FIG. 1 were prepared with the same weaving plan as described in Example 1 but with another yarn combination.

For the first ply, TY1 was used as weft and warp.

For the second ply, the weft and warp were prepared as follows: 100 wt % Kevlar® stretch broken fibers were ring spun into a single staple yarn Y2 using a conventional worsted staple processing equipment.

Yarn Y2 had a linear density of Nm 70/1 or 143 dtex and a twist of 620 TPM in the Z direction. Y2 was subsequently treated with steam to stabilize its tendency to wrinkle. Two Y2 yarns were then plied and twisted together. The resulting plied yarn (TY2) had a linear density of Nm 70/2 or 286 dtex and a twist of 600 TPM in the S direction. TY2 was used as warp yarn and weft yarn for the second ply.

A fabric weave having an array of Y-shaped connection lines like in Example 1 was prepared. This weave fabric had 38 ends/cm (warp) (19 ends/cm for each ply), 36 weft/cm (weft) (18 ends/cm for each ply) and a specific weight of 218 g/m².

The thus-obtained fabric was subjected to the same physical tests as Example 1, with the exception that the single layer fabric thickness according to DIN 53855 was measured before and after 8 s instead of after 4 s heat exposure. The fabric of this Example 2 was tested both as single layer (“Fabric” in Table 2a) and as the outershell of a multilayer structure (“Garment” in Table 2a). This multilayer structure further comprised: (1) an intermediate layer of a PTFE membrane laminate on a non-woven fabric made of 85 wt % Nomex@ and 15 wt % Kevlar® and having a specific weight of 135 g/m² (commercially available under the trade name GORE-TEX® Fireblocker N from W. L. Gore and Associates, Delaware, U.S.A.), and (2) an internal layer of a meta-aramid thermal barrier having a specific weight of 140 g/m² quilted on a 100 wt % Nomex® N 307 fabric having a specific weight of 110 g/m².

The excellent results shown in Table 2a are explained by the swelling of the fabric upon heat exposure into bubble like pockets that prevent heat convection. Table 2a shows a high increase of thickness after 8 seconds equal to a factor of ×2.

TABLE 2a

| | warp | weft |
|---|---|---|
| Breaking strength (N) | 2560 | 3085 |
| Elongation (%) | 8.8 | 7.2 |
| Tear resistance (N) | 385.4 | 384.7 |
| Dimensional change | −2.0 | −1.5 |
| after washing (%) | | |

| | |
|---|---|
| Fabric Thickness before | 1.17 |
| heat exposure (mm) | |
| Fabric Thickness after | 2.32 |
| 8 s heat exposure (mm) | |
| Specific Weight | 218 |
| (Fabric) (g/m²) | |
| Specific Weight | 603 |
| (Garment) (g/m²) | |
| TPP (Fabric) | |
| Time to record pain (s) | 4.8 |
| Second degree burn (s) | 7.4 |
| TPP rating (cal/cm²) | 14.7 |
| Fabric Failure Factor | 6.8 |
| (10² cal/g) | |
| TPP (Garment) | |
| Time to record pain (s) | 16.9 |
| Second degree burn (s) | 23.8 |
| TPP rating (cal/cm²) | 47.5 |
| Fabric Failure Factor | 7.9 |
| (10² cal/g) | |

Table 2a shows an excellent performance of the fabric in particular as outershell of the multilayered construction with an extremely high FFF value at 7.9×10² cal/g. The physical performance of the fabric with regard to breaking strength and tear resistance is also outstanding. A fabric with the same components and specific weight, but woven according to a standard monolayer construction, would show significantly lower physical performances. For example, a standard outershell woven twilled fabric of the given weight displays a tear resistance of 50-100 N and a tensile strength of 1000-1500 N, compared respectively to 385 N and 2500-3000 N measured on the fabric of the invention.

The fabric was tested as single layer in accordance with the TATE (Tensile After Thermal Exposure) method, as defined above, and under the same conditions as in Example 1. The results are summarized in Table 2b.

TABLE 2b

| | 0 s | 2 s | 4 s |
|---|---|---|---|
| Breaking strength N | 2560 | 2370 | 980 |
| Elongation at break % | 8.8 | 9.9 | 7.6 |

Conventional fabrics currently used in Europe as outershell of firefighter turn-out coats have a weight-normalized breaking strength value after 4 seconds (measured according to the TATE method) ranging between 1.8 N g⁻¹ cm² and 3.3 N g⁻¹ cm², while the fabric of this Example has a value of about 4.5 N g⁻¹ cm². This clearly shows that this fabric is eminently suitable as outershell of multilayered protective garments for fire fighters.

The examples confirm the superior performance of the fabric sheets according to the invention. However, of course the invention is not limited to the specific details of the examples. Many variations are possible within the scope of the appended claims, notably as regards the shape and the disposition of the connecting lines. Also, the described features are interchangeable and combinable where appropriate.

What is claimed is:

1. A thermally-resistant composite fabric sheet for use as single or outer layer of protective garments, comprising an inside fabric layer (B) and an outside fabric layer (A) joined together by an array of connection lines (12,22,32) arranged so that the inside layer forms bubble-like pockets (16) when the outside layer (A) is caused to shrink by the external application of intense heat,
characterized in that the array of connection lines (12,22,32) is constituted by a plurality of isolated single connection lines (22) and/or by a plurality of isolated groups of connection lines (12,32), the connection lines being arranged at different angles and being spaced apart from one another to leave, between the isolated single connection lines and/or between the isolated groups of connection lines, gaps (42) where the two layers (A,B) are not connected to one another, these gaps (42) uniting a continuous expanse (40) of the two unconnected layers that surrounds each isolated connection line (22) and/or each isolated group of connection lines (12,32), the continuous expanse (40) of unconnected layers having a labyrinth-like structure delimited by the connection lines (12,22,32) at different angles such that when a given area of the outside layer (A) is subjected to intense heat leading to thermal shrinkage the inside layer (B) forms under said given area a series of self-closing bubble-like pockets (16) that form individually in discrete areas of the continuous expanse (40) between the connecting lines (12,22,32) and that are inhibited by the labyrinth-like structure from propagating along or across the sheet outside said given area.

2. The fabric sheet of claim 1 wherein the connection lines (12,22,32) are arranged in a geometrically repeating pattern with the continuous expanse (40) forming wavy paths that meander around the pattern of lines.

3. The fabric sheet of claim 2, comprising a plurality of groups each composed of a plurality of connecting lines (12,22) arranged in a generally Y, V, L, T, H, X or Z configuration with the lines extending from at least one convergence point (14,24), the lines being connected together at, or being spaced apart from, their convergence point(s).

4. The fabric sheet of claim 3, comprising a plurality of groups each having three connecting lines (12,22) arranged in a generally Y-shaped configuration with the three lines extending from a convergence point (14,24), the lines being connected together at, or being spaced apart from, their convergence point.

5. The fabric sheet of claim 4, wherein at least two of the three lines (12,22) making up each Y are of substantially equal length.

6. The fabric sheet of claim 4, wherein two of the three lines (12,22) making up each Y are arranged symmetrically and at equal oblique angles to the third line.

7. The fabric sheet of claim 3, comprising a plurality of groups of two connecting lines (32) arranged in a generally V-shaped configuration with the two lines extending from a convergence point (34), the lines being connected together at or spaced apart from their convergence point.

8. The fabric sheet of claim 7, wherein the two lines (32) making up each V are at an angle of at least 60°, or at least 90° or at least 120°.

9. The fabric sheet of claim 1, comprising pluralities of groups of connecting lines (12,22,32) arranged in rows with adjacent rows of groups offset to one another.

10. The fabric sheet of claim 9, wherein at least some of the lines (12,22,32) of each group are parallel to corresponding lines of the other groups.

11. The fabric sheet of claim 10, wherein parallel lines (12,22,32) of different groups are all exactly or approximately aligned with and parallel to lines of the other groups.

12. The fabric sheet of claim 10, wherein parallel lines (12,22,32) of different groups are offset from parallel lines of the other groups.

13. The fabric sheet of claim 9, wherein pluralities of groups of connecting lines (12,22,32) are aligned in rows in at least two different directions across the fabric sheet.

14. The fabric sheet of claim 1, comprising a plurality of curved connection lines.

15. The fabric sheet of claim 1, wherein the inside fabric layer (B) and outside fabric layer (A) are both woven fabrics and are joined together by an array of woven connection lines (12,22,32) formed by interwoven threads making up the fabrics.

16. The fabric sheet of claim 1, wherein at least one of the inside fabric layer (B) and the outside fabric layer (A) is made from a fiber blend comprising a first inherently flame resistant fiber of relatively low modulus, a second inherently flame resistant fiber of relatively high modulus, and sacrificial fibers having a lesser resistance to flames.

17. The fabric of claim 16, wherein said fiber blend comprises from about 40 to 60 wt % meta-aramid fibers of relatively low modulus, about 20 to 40 wt % of para-aramid fibers of relatively low modulus, and about 10 to 30 wt % of pre-oxidised polyacrylonitrile as sacrificial fibers.

18. A garment, in particular a garment for exposure to high temperature environments, comprising a fabric sheet as claimed in claim 1 wherein the outside fabric layer (A) of the fabric sheet is disposed on the outside of the garment.

19. A garment as claimed in claim 18, made of said fabric sheet which is unlined and with the outside fabric layer (A) of the fabric sheet oriented outwards.

20. A garment as claimed in claim 19, made of said fabric sheet whose inside fabric layer (B) is lined with one or more further fabric layers in a multi-layer structure.
